(19) United States
(12) Patent Application Publication
(10) Pub. No.: US 2016/0019681 A1
(43) Pub. Date: Jan. 21, 2016

(54) IMAGE PROCESSING METHOD AND ELECTRONIC DEVICE USING THE SAME

(71) Applicant: ASUSTeK COMPUTER INC., Taipei City (TW)

(72) Inventor: Yi-Chi Cheng, Taipei City (TW)

(21) Appl. No.: 14/800,707

(22) Filed: Jul. 16, 2015

(30) Foreign Application Priority Data
Jul. 17, 2014 (TW) 103124564

(51) Int. Cl. G06T 5/00; H04N 5/355; H04N 5/235; G06T 1/00; G06T 5/50

(52) U.S. Cl. CPC G06T 5/009; G06T 1/0007; G06T 5/50; H04N 5/2353; H04N 5/35581; G06T 2207/10004; G06T 2207/10144; G06T 2207/20208; G06T 2207/30168

(57) ABSTRACT

The present invention discloses an image processing method and an electronic device using the same. The image processing method includes the following steps: (a) capturing a plurality of reference images corresponding to a plurality of exposure values; (b) executing a high dynamic range (HDR) algorithm based on the reference images to generate an HDR image; (c) enhancing an image quality of each of the reference images to generate a plurality of processed images; (d) selecting a candidate image which is most similar to the HDR image from the processed images; and (e) recording a first candidate automatic exposure value corresponding to the candidate image.

### CROSS-REFERENCE TO RELATED APPLICATION

This application claims the priority benefit of Taiwan application serial no. 103124564, filed on Jul. 17, 2014. The entirety of the above-mentioned patent application is hereby incorporated by reference herein and made a part of this specification.

### BACKGROUND OF THE INVENTION

1. Field of the Invention

The invention relates to an image processing method and, more particularly, to an image processing method for adjusting an automatic exposure value.

2. Description of the Related Art

Most electronic devices, such as a digital camera or a smart phone, support a high dynamic range (HDR) function. When HDR executes, the details of the bright parts and the dark parts in the photos that taken by the electronic devices are improved, and the objects shown in the photo are clearer.

Currently, HDR technology is used to get a better effect in taking photos, such as making the dark parts more clear and avoiding an overexposure of the bright parts. To achieve the purpose, an HDR image is generated by integrating multiple photos with different exposure values. First, in order to make the dark parts clear, the photos are taken with long exposures to make the dark parts brighter. Then, in the same scene, the photos are taken with short exposure to make the bright parts darker and avoid overexposure.

Please refer to FIG. 1; FIG. 1 is a schematic diagram showing a conventional HDR technology. When HDR function of the electronic device is enabled, multiple photos 110, 120 and 130 are taken by the electronic device simultaneously. The first photo 110 may be a short-exposure photo taken with a first exposure value by the electronic device, and it shows the bright part of the scene. The second photo 120 is taken with a second exposure value by the electronic device. The third photo 130 may be a long-exposure photo taken with a third exposure value by the electronic device, and it shows the dark part in the scene. Then, the electronic device combines all the photos 110, 120 and 130 to generate the photo 140. Thus, the photo 140 shows the dark part clearly and shows the bright part without overexposure.

However, it needs to take more than two photos with different exposure values in a short time to generate an HDR image, and thus the immediacy of HDR mechanism is low. From another aspect, if the automatic exposure mechanism of the electronic device is set to a constant exposure value without considering the subsequent image processing algorithm, and when the photo is taken in a high global contrast environment (such as backlight or towards the light), the dark parts corresponding to backlight places in the photo cannot be shown clearly and cannot be improved by the conventional automatic exposure mechanism.

### BRIEF SUMMARY OF THE INVENTION

An image processing method applied to an electronic device is provided. The image processing method includes following steps: (a) capturing a plurality of reference images corresponding to a plurality of exposure values; (b) executing a high dynamic range (HDR) algorithm based on the reference images to generate an HDR image; (c) enhancing an image quality of each of the reference images to generate a plurality of processed images; (d) selecting a candidate image which is most similar to HDR image from the processed images; and (e) recording a first candidate automatic exposure value corresponding to the candidate image.

An electronic device is provided to obtain an optimal automatic exposure value. The electronic device includes an image capturing unit, a first image generating unit, a second image generating unit, an image selecting unit and a recording unit. The image capturing unit captures a plurality of reference images corresponding to a plurality of exposure values. The first image generating unit executes an HDR algorithm based on the reference images to generate an HDR image. The second image generating unit enhances an image quality of each of the reference images to generate a plurality of processed images. The image selecting unit selects a candidate image which is most similar to the HDR image from the processed images. The recording unit records a first candidate automatic exposure value corresponding to the candidate image.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional HDR technology;

FIG. 2 is a block diagram showing an electronic device in an embodiment;

FIG. 3 is a flow chart showing an image processing method in an embodiment;

FIG. 4 is a schematic diagram showing reference images and an HDR image in an embodiment;

FIG. 5 is a schematic diagram showing processed images according to the embodiment in FIG. 4;

FIG. 6 is a graph showing an SSIM between each of the processed images in FIG. 5 and an HDR image;

FIG. 7 is a schematic diagram showing different images captured in an outdoor environment in an embodiment; and

FIG. 8 is a schematic diagram showing different images captured in an indoor environment in an embodiment.

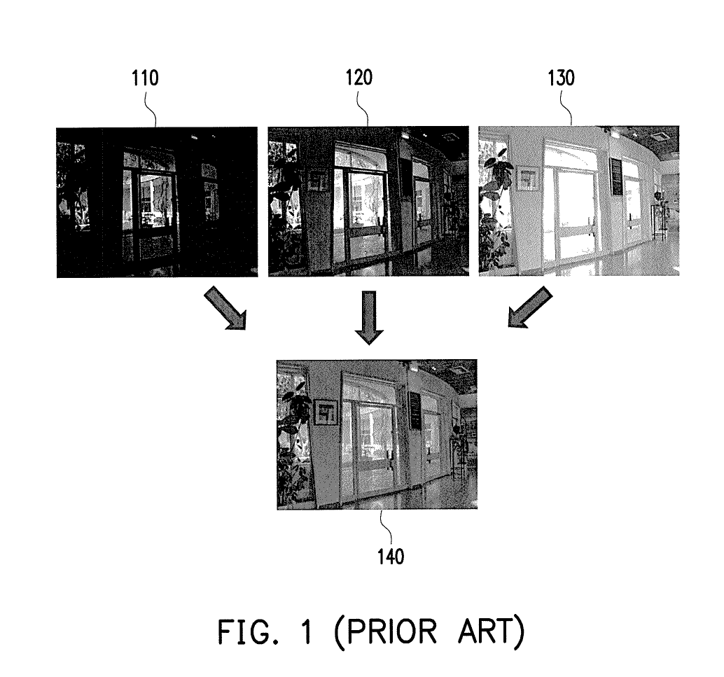

### DETAILED DESCRIPTION OF THE EMBODIMENTS

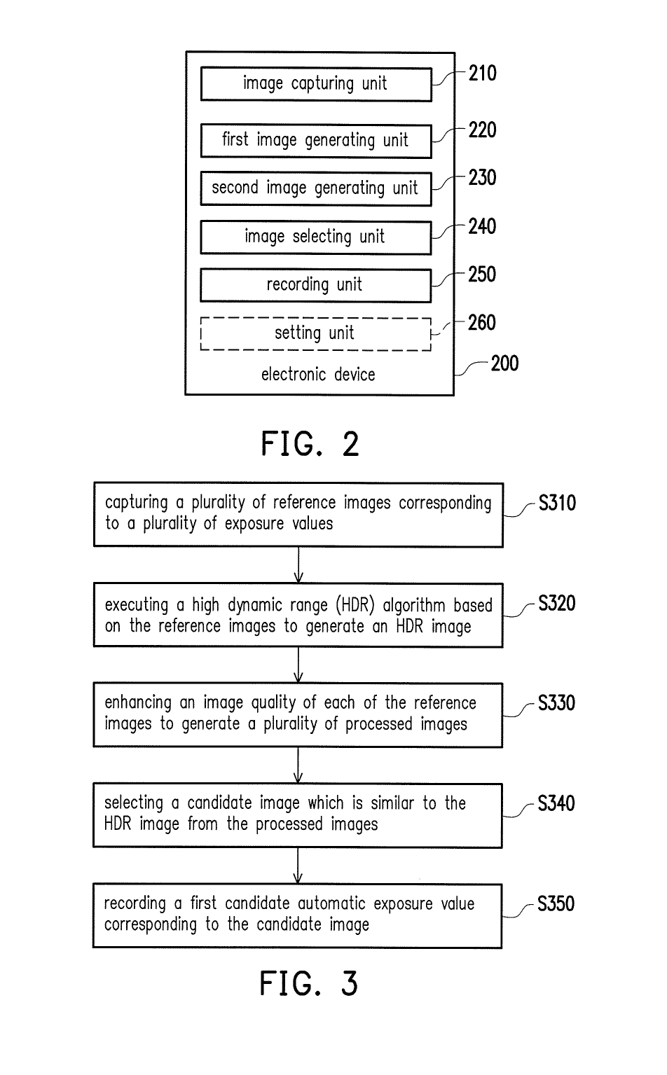

FIG. 2 is a block diagram showing an electronic device in an embodiment. In the embodiment, the electronic device 100 includes an image capturing unit 210, a first image generating unit 220, a second image generating unit 230, an image selecting unit 240 and a recording unit 250. The electronic device 100 may be a smart phone, a tablet computer, a notebook computer, a personal digital assistant (PDA) or other devices which can capture images.

The image capturing unit 210 may be a camera with a charge coupled device (CCD) lens, a complementary metal oxide semiconductor transistors (CMOS) lens or an infrared radiation (IR) lens, and it may also be an image capturing device which can capture depth data, such as a depth camera or a three-dimension (3D) camera.

The first image generating unit 220, the second image generating unit 230, the image selecting unit 240 and the recording unit 250 may be hardware, software or program codes stored in storage units. The storage unit may be a memory or a hard disk which can store program codes or modules.

When the first image generating unit 220, the second image generating unit 230, the image selecting unit 240 and the recording unit 250 are achieved via software or program codes, they can be loaded to a processing unit (not shown) to execute the method for obtaining an optimal automatic exposure value.

The processing unit may be a processor for common use, a processor for special use, a conventional processor, a digital processor, a plurality of microprocessors, one or more microprocessors with digital signal processor cores, a controller, a micro-controller, an application specific integrated circuit (ASIC), a field programmable gate array (FPGA), an integrated circuit, a state machine, or an advanced reduced instruction-set computer (RISC) machine (ARM).

FIG. 3 is a flow chart showing an image processing method in an embodiment. The method can be executed by the electronic device 200 in FIG. 2. The details of the method are illustrated with the components in FIG. 2 in the following.

In step S310, the image capturing unit 210 captures a plurality of the reference images corresponding to a plurality of the exposure values. In an embodiment, in order to make the optimal automatic exposure value suitable for taking images in a backlight environment, the reference images corresponding to a plurality of the exposure values can be captured in a backlight environment.

In step S320, the first image generating unit 220 executes an HDR algorithm based on the reference images to generate an HDR image. That means, the first image generating unit 220 selects several images from the reference images, and combines the selected image to generate an HDR image.

In step S330, the second image generating unit 230 enhances an image quality of each of the reference images to generate a plurality of the processed images. In an embodiment, the second image generating unit 230 can process the reference images based on tone mapping to generate the processed images. For example, the second image generating unit 230 can finely adjust the exposure value of each of the reference images to generate the processed image whose exposure value is different from each of the reference images, which is not limited herein.

Although the step S330 is after the step S320 in FIG. 3, in other embodiments, the step S330 may be executed before the step S320, or the steps S320 and S330 are executed simultaneously.

In step S340, the image selecting unit 240 selects a candidate image which is most similar to the HDR image from the processed images. In an embodiment, the image selecting unit 240 executes an image quality evaluating algorithm based on the processed images and the HDR image to calculate a similarity between each of the processed images and the HDR image. Then, the image selecting unit 240 selects a specific image corresponding to a highest similarity from the processed images as the candidate image. The similarity can be represented by a structural similarity (SSIM) between the HDR image and each of the processed images. The image selecting unit 240 can determine which one of the processed images is most similar to the HDR image based on the SSIM, and sets the determined processed image as the candidate image.

In step S350, the recording unit 250 records a first candidate automatic exposure value corresponding to the candidate image. In other embodiments, when the electronic device 200 captures an image in a same scene, the image capturing unit 210 directly uses the first candidate automatic exposure value to capture an image. Thus, the electronic device 200 does not need to generate the HDR image via a conventional HDR mechanism, and it only needs to capture an image based on a single exposure value to obtain the image which is similar the HDR image. In other words, the electronic device 200 can capture the image which is similar to the HDR image without using the HDR mechanism. From another aspect, the electronic device 200 can apply an automatic exposure mechanism to achieve an effect similar to the HDR mechanism, and thus it can effectively improve the immediacy of the image processing.

In other embodiments, the electronic device 200 may further include a setting unit 260. The setting unit 260 can be achieved via a hardware element or a software module, which is not limited herein. In order to make the automatic exposure value suitable for different scenes for capturing an image, after the step S340, the image capturing unit 210, the first image generating unit 220, the second image generating unit 230, the image selecting unit 240 and the recording unit 250 execute the steps S310 to S340 repeatedly to obtain a plurality of second candidate automatic exposure values corresponding to different environments. Additionally, the setting unit 260 calculates an average value of the first candidate automatic exposure value and the second candidate automatic exposure values, and sets the average value as the automatic exposure value of the image capturing unit 210. Then, the image capturing unit 210 can directly capture an image based on the automatic exposure value. Consequently, the electronic device 200 can obtain an image which is similar to HDR image based on a single automatic exposure value in different scenes.

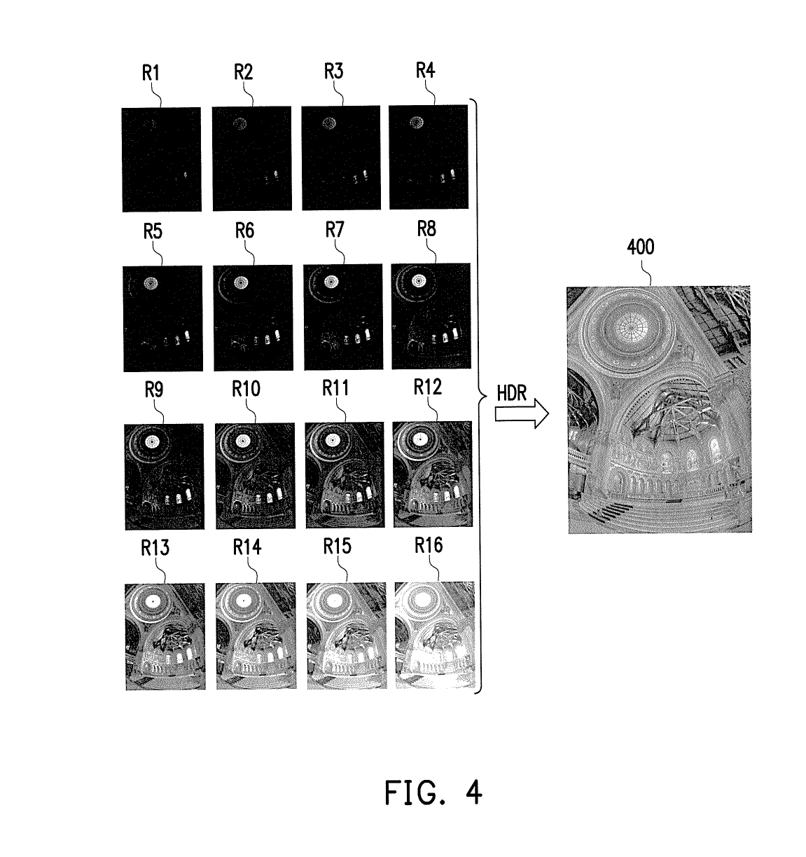

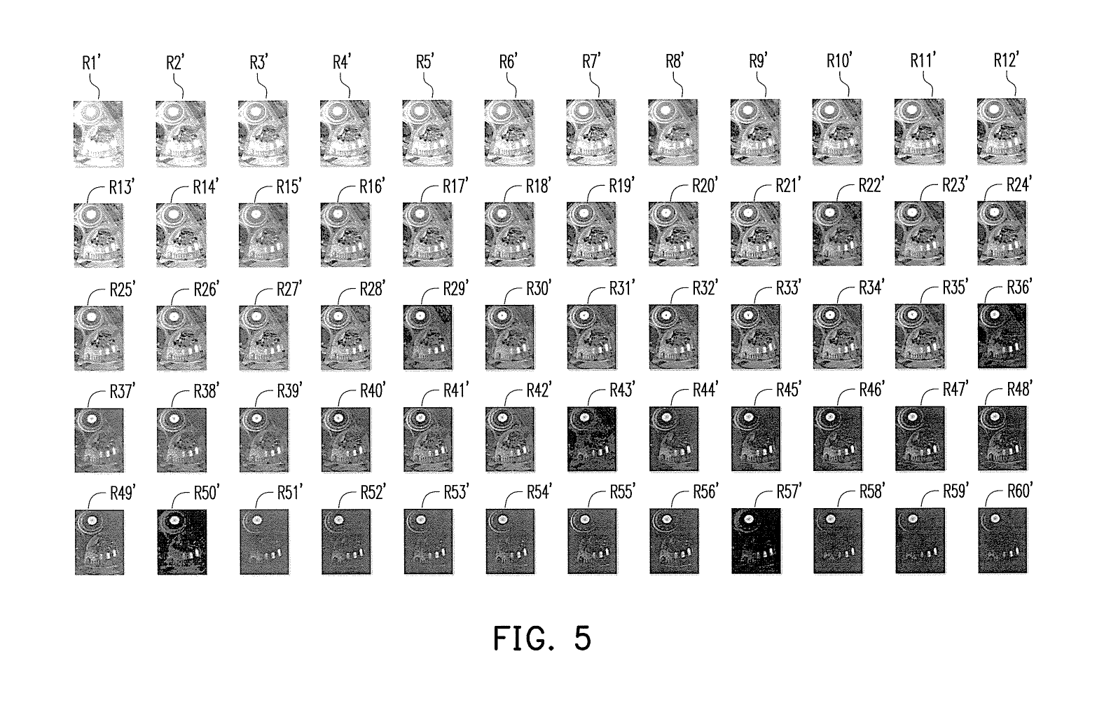

FIG. 4 is a schematic diagram showing the reference images and the HDR image in an embodiment. In the embodiment, it assumes that the reference images R1 to R16 captured by the image capturing unit 210 corresponds to different exposure values. Then, the first image generating unit 220 executes the HDR algorithm based on the reference images R1 to R16 to generate the HDR image 400, and the second image generating unit 230 enhances the image quality of each of the reference images R1 to R16 to generate a plurality of the processed images.

FIG. 5 is a schematic diagram showing the processed images according to the embodiment in FIG. 4. The processed images R1′ to R60′ in the embodiment are generated based on the reference images R1 to R16 in FIG. 4 by the second image generating unit 230. In the embodiment, the second image generating unit 230 may generate the processed images R1′ to R60′ based on tone mapping, which is not limited herein. Then, the image selecting unit calculates the similarity (such as the SSIM) between each of the processed images R1′ to R60′ in FIG. 5 and the HDR image 400.

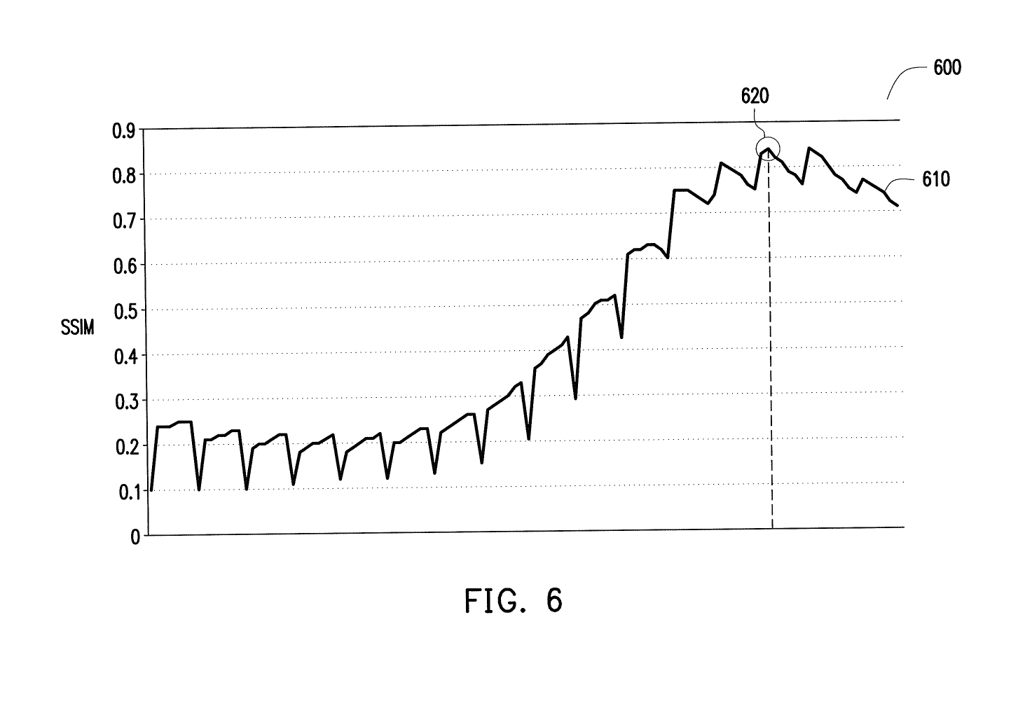

FIG. 6 is a graph showing the SSIM between each of the processed images in FIG. 5 and the HDR image. In the embodiment, the vertical axis of the graph 600 represents the SSIM value, and the horizontal axis corresponds to each of the processed images R1′ to R60′ in FIG. 5. As shown in the graph 600, the curve 610 has a peak value 620. In other words, the processed image corresponding to the peak value 620 is the image which is most similar to the HDR image 400, and it is the candidate image. Then, the recording unit 250 records the exposure value of the candidate image, and sets the exposure value as the automatic exposure value of the image capturing unit 210.

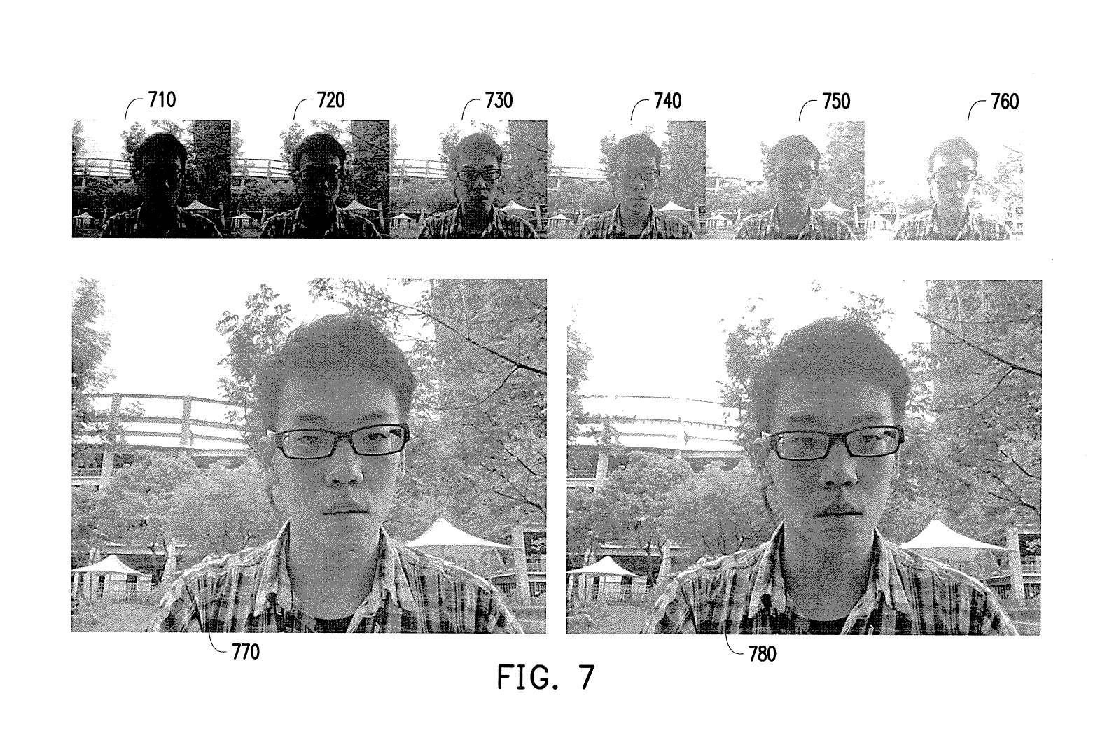

FIG. 7 is a schematic diagram comparing the effects of the different images captured in an outdoor environment in an embodiment. In the embodiment, it assumes that the reference images 710 to 760 correspond to different exposure values, respectively, and the HDR image 770 is generated based on the reference images 710 to 760. The image 780 is captured according to the first candidate automatic exposure value of the embodiment in FIG. 3. As shown in FIG. 7, the effect of the image 780 which is captured based on a single exposure value is very similar to that of the HDR image 770. That means, the image captured based on the first candidate automatic exposure value can be very similar to the HDR image.

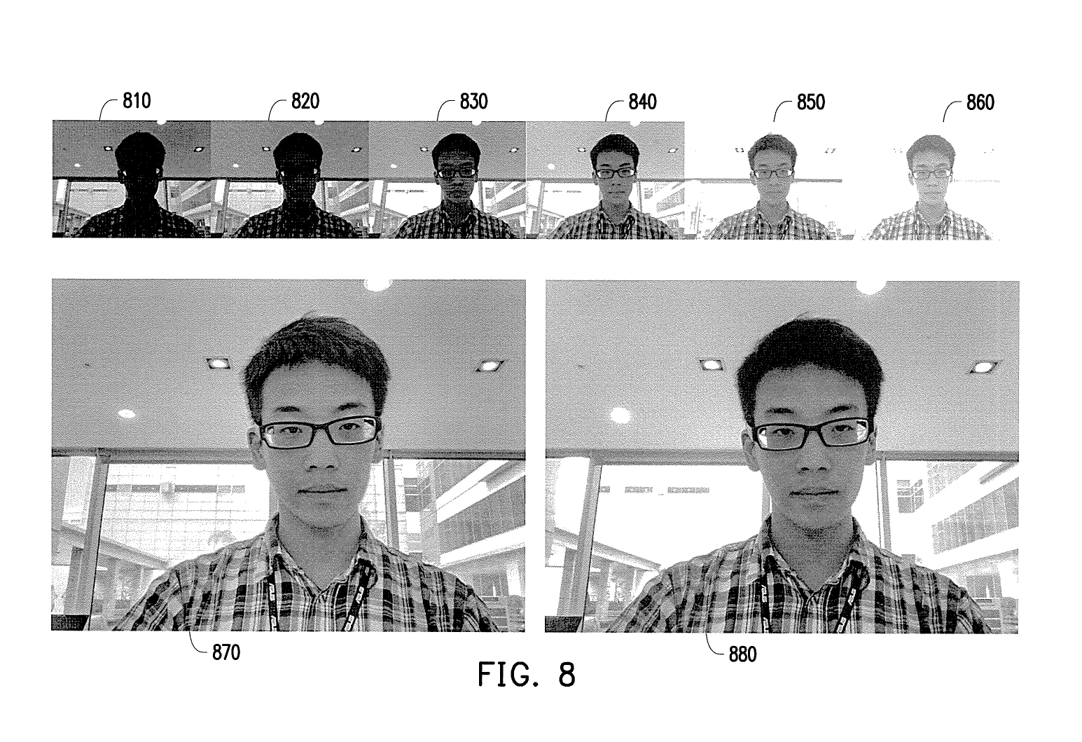

FIG. 8 is a schematic diagram comparing the effects of the different images captured in an indoor environment in an embodiment. In the embodiment, it assumes that the reference images 810 to 860 correspond to different exposure values, respectively, and the HDR image 870 is generated based on the reference images 810 to 860. The image 880 is captured according to the first candidate automatic exposure value of the embodiment in FIG. 3. As shown in FIG. 7 and FIG. 8, no matter where the image is captured, it can be very similar to the HDR image via the image processing method.

In sum, the image processing method and the electronic device using the same can select the image most similar to the HDR image from the images corresponding to different exposure values, the exposure value used by the electronic device in capturing subsequent images is determined based on the exposure value of the selected image. Consequently, the electronic device does not need to apply the conventional HDR mechanism to generate the HDR image, and it can capture an image which is similar to the HDR image based on a single exposure value. From another aspect, the electronic device can apply the automatic exposure mechanism to achieve the effect similar to that of the HDR mechanism, which can effectively improve the immediacy of the image processing.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An image processing method applied to an electronic device, the image processing method comprising following steps:
(a) capturing a plurality of reference images corresponding to a plurality of exposure values;
(b) executing a high dynamic range (HDR) algorithm based on the reference images to generate an HDR image;
(c) enhancing an image quality of each of the reference images to generate a plurality of processed images;
(d) selecting a candidate image which is most similar to the HDR image from the processed images; and
(e) recording a first candidate automatic exposure value corresponding to the candidate image.

2. The image processing method according to claim 1, wherein the step of capturing the plurality of the reference images corresponding to the plurality of the exposure values includes:
capturing the reference images corresponding to the exposure values in a backlight environment.

3. The image processing method according to claim 2, wherein the step of selecting the candidate image which is most similar to the HDR image from the processed images includes:
executing an image quality evaluating algorithm based on the processed images and the HDR image to calculate a similarity between each of the processed images and the HDR image; and
selecting a specific image corresponding to a highest similarity from the processed images as the candidate image.

4. The image processing method according to claim 3, wherein after the step of recording the first candidate automatic exposure value corresponding to the candidate image, the image processing method further includes:
executing the step (a) to the step (e) repeatedly to obtain a plurality of second candidate automatic exposure values corresponding to different environments;
calculating an average value of the first candidate automatic exposure value and the second candidate automatic exposure values; and
setting the average value as an automatic exposure value of the electronic device.

5. The image processing method according to claim 4, wherein after the step of setting the average value as the automatic exposure value of the electronic device, the image processing method further includes:
capturing an image based on the automatic exposure value.

6. An electronic device, comprising:
an image capturing unit capturing a plurality of reference images corresponding to a plurality of exposure values;
a first image generating unit executing an HDR algorithm based on the reference images to generate an HDR image;
a second image generating unit enhancing an image quality of each of the reference images to generate a plurality of processed images;
an image selecting unit selecting a candidate image which is most similar to the HDR image from the processed images; and
a recording unit recording a first candidate automatic exposure value corresponding to the candidate image.

7. The electronic device according to claim 6, wherein the image capturing unit captures the reference images corresponding to the exposure values in a backlight environment.

8. The electronic device according to claim 7, wherein the image selecting unit executes an image quality evaluating algorithm based on the processed images and the HDR image to calculate a similarity between each of the processed images and the HDR image, and the image selecting unit selects a specific image corresponding to a highest similarity from the processed images as the candidate image.

9. The electronic device according to claim 8, wherein the electronic device further includes a setting unit, the image capturing unit, the first image generating unit, the second image generating unit, the image selecting unit and the recording unit operate repeatedly to obtain a plurality of second candidate automatic exposure values corresponding to different environments, the setting unit calculates an average value of the first candidate automatic exposure value and the second candidate automatic exposure values, and the setting unit sets the average value as an automatic exposure value of the electronic device.

10. The electronic device according to claim 9, wherein the image capturing unit captures an image based on the automatic exposure value.
